(19) United States
(12) Patent Application Publication
(10) Pub. No.: US 2026/0018149 A1
(43) Pub. Date: Jan. 15, 2026

(54) ELECTRONIC STRING INSTRUMENTS

(71) Applicant: Digital Strings Music Inc., Coquitlam (CA)

(72) Inventor: Reza Ahmadian Yazdi, Coquitlam (CA)

(21) Appl. No.: 18/766,725

(22) Filed: Jul. 9, 2024

(51) Int. Cl. G10H 1/34; G10H 1/00; G10H 1/12; G10H 1/44

(52) U.S. Cl. CPC G10H 1/342; G10H 1/0016; G10H 1/0066; G10H 1/125; G10H 1/44; G10H 2220/201

(57) ABSTRACT

A system and method for musical instruments with electronically tuned strings. The system comprises an instrument body designed to comprise a plurality of sensors configured to simulate strings on a music instrument. The sensors are designed to receive interaction and input from a user similarly to how strings behave on a string instrument, further comprising a processor and at least one output module. The system is implemented with a user control device configured to receive, store, and transmit at least one music profile, an output device, and a network configured to connect the user device and the output device to the instrument body. The sensors are configured to detect input factors when a user interacts with the sensors, wherein the input factors are transmitted to the processor. The processor then directs the output module to produce a number of musical notes based on the input factors and the music profile.

### BACKGROUND

Tuning string instruments like Santoor and Hammer Dulcimer is very time consuming and difficult. Changing the tuning in the middle of play is difficult to impossible and limited notes are available. There exists a need to solve the tuning problem of musical instruments and to provide for the instant change of tuning for such musical instruments.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various embodiments, a musical instrument system with electronically tuned strings is provided. The system comprises an instrument body, which is designed to comprise a plurality of sensors configured to simulate strings on a music instrument. The sensors are designed to receive interaction and input from a user similarly to how strings behave on a string instrument. The system further comprises a processor and at least one output module. The system is implemented with a user control device configured to receive, store, and transmit at least one music profile, an output device, and a network configured to connect the user device and the output device to the instrument body. The sensors are configured to detect input factors when a user interacts with the sensors, wherein the input factors are transmitted to the processor. The processor then directs the output module to produce a number of musical notes based on the input factors and the music profile.

In various embodiments, a method for producing music with electronically tuned strings is provided. The method comprises receiving at least one music profile from a user on a user device; tuning a plurality of sensors electronically to correspond to the at music profile; receiving at least one music input from a user interacting with the sensors; detecting at least one music input factors for the music input; transporting the music input factors to a processor; determining, using the processor, a plurality of music notes according to the music input factors; generating, using an output module, music notes on the music instrument based on the user input, adjusted according to the music profile and the music input factors; adjusting the strings instantly upon receiving tuning input from the user; and producing a plurality of musical data elements based on the music notes and transmitting the plurality of musical data elements to an output device.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a schematic diagram of an electronic string instrument system in accordance with the subject disclosure.

FIG. 2 is an exemplary process in accordance with the subject disclosure.

### DETAILED DESCRIPTION

The subject disclosure is directed to an electronic instrument with sensors that simulate strings. By replacing the strings with electronic sensors and pre-recorded samples, there is no need for tuning and tuning can be changed instantly.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to a “module”, “a software module”, and the like, indicate a software component or part of a program, an application, and/or an app that contains one or more routines. One or more independently modules can comprise a program, an application, and/or an app.

References to an “app”, an “application”, and a “software application” shall refer to a computer program or group of programs designed for end users. The terms shall encompass standalone applications, thin client applications, thick client applications, web-based applications, such as a browser, and other similar applications.

References to “profile”, “musical profile”, and the like, should be understood to include, broadly, different music notes from different instruments or differently tuned notes from same instrument.

Numerous specific details are set forth in order to provide a thorough understanding of one or more embodiments of the described subject matter. It is to be appreciated, however, that such embodiments can be practiced without these specific details.

The electronic string method and system is designed for eliminating, using sensors and pre-recorded samples, the need of tuning strings on a musical instrument. The system and method are implemented in a string instrument, such as a santoor or a dulcimer in an exemplary embodiment, where music is produced by percussive actions performed on the strings thereon. In the electronic string system, strings are replaced by sensors, such that reactions of strings from traditional string instruments can be replaced by digital interaction with the sensors. As a result, the electronic string system and method can instantly change tuning at any time through control mechanisms, such as a touch screen or a foot pedal that is connected to the electronic string instruments.

The electronic string method and system are implemented by replacing the strings on traditional string instruments with sensors, such that each string would take the place of a corresponding string on an instrument. In various embodiments, this system and method can be implemented in string instruments of various origins, such as santoor, dulcimer, guitar, bass, etc. Each sensor is designed to detect input from a user and analyze the input factors associated therein. Just as a string would respond to a user's interaction depending on the angle, force, velocity, activation duration, and gesture, the sensors in the electronic string system would recognize such factors and transmit the information to the processor and output modules.

The processor stores pre-recorded samples, songs, music notes, and tuning information, and would apply each according to the input factors received. Similar to the how a musical instrument's body is attuned to produce musical notes based on behavior of the strings, the processor would direct the output modules to produce the appropriate sound based on the input factors received on the sensors. In practice, this allows the electronic string instrument to be played in the same manner as a traditional music instrument, but with the additional ability to tune the strings instantly at any time.

Traditional instruments require constant maintenance and tuning to upkeep the strings. Should a user want to change the tuning for musical notes in a different profile, it would involve a lengthy process of physically tuning each string individually. Further, each instrument is generally associated with a particular sound or origin, such that western piano sound cannot be generated from a Persian originated instrument such as a santoor. As such, it is necessary to keep multiple instruments if a user desires the ability to play music in multiple origins.

The electronic string instrument system and method eliminates the need for individually tuning multiple instruments by allowing instantly modification of music output via the processor and a control interface. In various embodiments, a touch screen, keypad, or foot pedal can be utilized to instantly load alternative musical notes into the instrument processor, such that the input factors detected from the sensors would trigger production of alternative musical notes on the output module. Each string or sensor can be further configured individually, such that more complex sound and tune combinations that otherwise would be impossible to produce on one instrument would be generated from a singular electronic string instrument system.

The electronic string instrument system and method comprises capability to add any digital filters and effects on samples and activate them through touch screen, foot pedal, or other means. Exemplary filters and effects include Reverb, Echo, Modulation, PitchBend, and other similar filters and effects. In this exemplary embodiment, the digital filters can be activated instantly.

A feature of the electronic string instrument system provides for ability to add, modify, or remove sound and tone effects to the audio output, such that various tunes can be played from the same input factors. This allows instantaneous modification of music production without the need to tune the music instrument manually.

The electronic string instrument system incorporates specific sensor design and associated hardware circuitry to detect notes that are played by a user in real time. The notes are detected and analyzed through input factors such as velocity, force, angle, gesture, activation duration, and more. The manner upon which each sensor is activated is analyzed in the processor to associate the appropriate audio output according to the various input factors.

The electronic string instrument system and method comprises software routines to identify specific gestures during play. In various embodiments, software programs can be stored and installed in the processing unit of the instrument, such that the sensors can be configured to detect different manners of music playing. As an example, the manner a player interacts with a traditional santoor is different from that of a traditional dulcimer, and the electronic string instrument would incorporate different software programs to properly associate with each intended instrument.

The electronic string instrument system provides full capability of tuning each individual sensor separately. This provides full flexibility to the instrument and is capable of assigning to each sensor different samples. This configuration would allow users to set up the electronic string instrument to produce complex sound that is previously impossible to achieve on a single instrument.

The electronic string instrument system comprises capability to record, save, and delete entire audio output, such that songs played on the instrument system can be converted into a series of data elements that can be shared with others. In various embodiments, the electronic string instrument system is connected to other user devices through a computing network, such as WiFi, Ethernet, email, USB, or Bluetooth. The data elements can include song files, data streams, or other similar forms of output. The data elements, especially when they are in song file form, can be converted into various formats to enable efficient file sharing capabilities.

The electronic string instrument system comprises integrated speakers and headphone output and line outputs in order to play the sound directly to external amplifiers. This setup would further enable MIDI output to use the digital audio workstations (DAW) and create sheet music real time, whiling playing.

In various embodiments, the electronic string instrument system comprises integrated metronome with full capability of tuning for different tempo/beat/volume, etc. The electronic string instrument system further comprises integrated sequencer with full capability of tuning for different tempo or volume and making custom rhythms.

In various embodiments, the electronic string instrument system comprises visual indicators to show when a sensor is activated and used for teaching purposes. The indicators can include a visual indicator for the notes that are being played by the user, a visual indicator for the notes played by the system to enhance learning, and any other suitable visual indicator. These features, combined with the functions previously described, provide a comprehensive instructional function to show case the music playing process.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

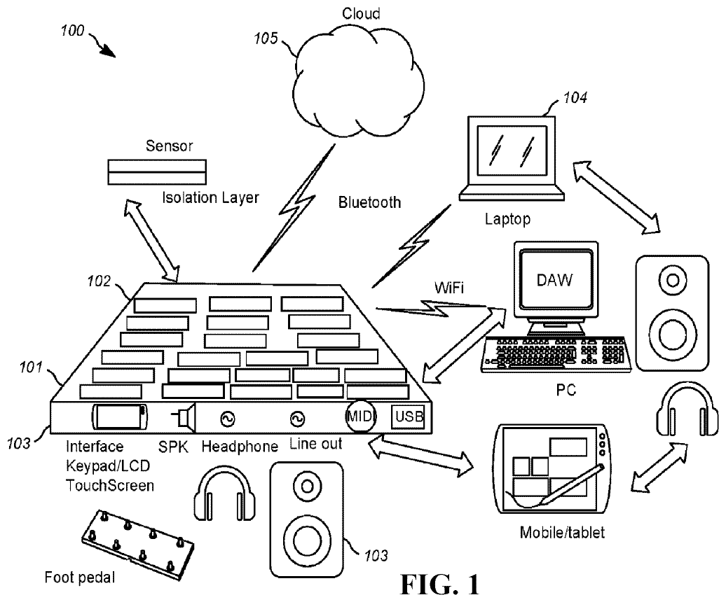

Now referring to the drawings and particularly to FIG. 1, various features of the subject disclosure are now described in more detail with respect to an electronic string instrument system, hereby designated as 100. The electronic string instrument system 100 comprises an instrument body 101 and a plurality of sensors 102. The sensors 102 are installed on the instrument body 101 on top of an isolation layer. In the exemplary embodiment, the plurality of sensors 102 are laid out in a manner that resembles the string layout of a traditional santoor. In various other embodiments, a person with ordinary skills in the art can modify and adapt the electronic string instrument system 100 to represent other traditional musical instrument that would incorporate strings or keys. A process would be incorporated in the instrument body 101, such that a user's interaction with the sensors 102 can be analyzed to isolate the relevant input factors.

The sensors 102 are set up to simulate the layout and feel of strings on a santoor, in the exemplary embodiment in FIG. 1. Each sensor 102 is configured to detect manner of play thereon, in order to differentiate the various playing method in relation to a traditional string instrument. As such, each sensor can be interacted with as if a user is acting (i.e., striking, plucking, damping, pressing, etc.) upon the strings in a traditional string instrument. These interactions are often characterized by velocity, angle, force, activation duration, and other relevant factors. Just as a player would choose to interact with a string differently to produce different desired sound, these varying interactions are replicated on the sensors and their associated input factors are analyzed by the processor onboard. The processor module would apply the various input factors to produce the corresponding music notes through a number of output modules 103.

In various embodiments, visual indicators can be incorporated onto the instrument body 101, in association with each digital sensor 102. This configuration would allow the instrument system 100 to show when a sensor is activated. This provides instructional values to those who are learning to play certain musical pieces.

In the exemplary embodiment, the output modules 103 comprise a speaker, headphone jack, audio line out port, MIDI port, and USB port. The output modules 103 can be customized to suit the requirement of each user. Depending on the desired output format, a number of output modules would be utilized. This customizable output modules setup allow the electronic string instrument system to be utilized in various settings. Should a user choose to practice with the instrument in their own privacy, they can elect to only use the headphone jack as the output, thereby limiting the output to only those with the associated headphones. Alternatively, the user can elect to associate the instrument system with a sound system at a performance venue, such that the music produced by the electronic string instrument system can be broadcasted directly through the venue. Further, the music output can be generated into files that can be shared through MIDI ports or USB drives, among a plethora of file sharing channels.

The digital instrument system 100 are configured to store various software routines to further enhance the analysis functions of the sensors 102. Just as different manners of interacting of strings would be utilized for different string instruments, the digital instrument system 100 can be configured to simulate various music instruments. As such, the sensors 102 can be configured to detect patterns associated with specific instruments, and can be configured instantly through a number of control modules.

Each sensor 102 can be configured independently, such that each key can be associated with a different traditional instrument. This provides the electronic string instrument system 100 with the ability to generate complex musical tones that are impossible to achieve on traditional musical instruments. The configuration of each sensor 102 can be done instantly through control modules and can be done at any time.

A number of user devices 104 can be connected to the digital instrument body 101 through a network 105. The network can be established through WiFi, Bluetooth, ethernet, etc. The user devices 104 can be implemented as a tablet, a laptop computer, or a mobile phone device. In various embodiments, the user devices 104 can be configured to electronically interact with the sensors 102 and the output module 103. As previously stated, different software routines can be implemented for the sensors 102 to interpret playing notes on different instruments. Such software routines can be selected, modified, and sent from the user devices 104. In an exemplary embodiment, this allows an instructor user to modify the tuning state of the instrument system 100 remotely, while monitoring a student's performance. Similarly, a user can receive stream of output from the output modules 103, while connected to the instrument body 101 digitally. This allows a plurality of music files and/or data streams produced by the instrument 100 to be shared remotely and instantly.

It should be understood that, while a network is disclosed in this exemplary embodiment, other types of connections are suitable.

A number of output devices 108 can be incorporated into the electronic string instrument system 100. In various embodiments, the output devices 108 comprise speakers, headphones, local sound system, PA system, and more. The various output devices 108 can be adapted to suit specific needs of each application, such that appropriate output can be provided to the right channel.

In various embodiments, musical playing assistant modalities such as metronome and sequencers can be incorporated into the instrument body 101. The assistant modalities can be associated with the processors, such that instructions and guidelines can be issued through or from the user devices 104. In various embodiments, a user can select and issue metronome guidelines through a suer device 104, such that visual or audio indicators can be generated in the music playing process on the instrument body 101.

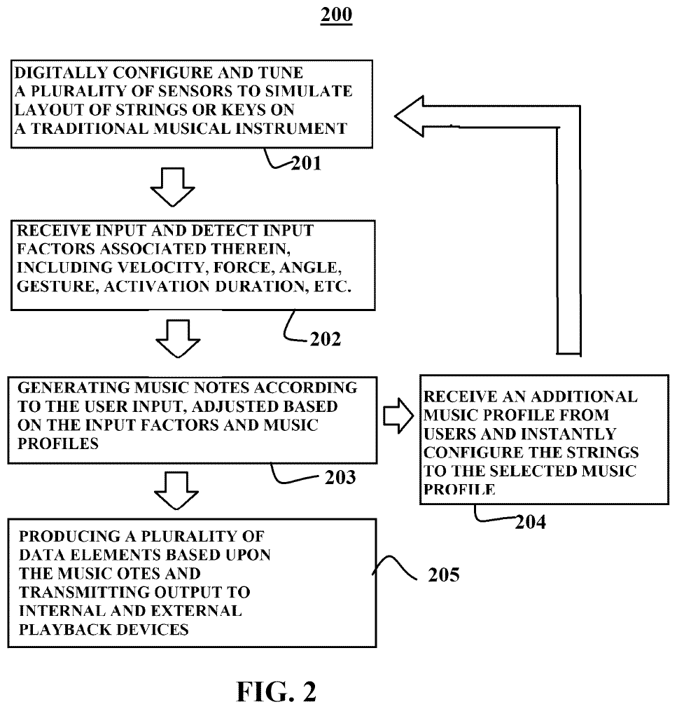

Referring to FIG. 2, an exemplary process utilizing the electronic string instrument system is generally designated as 200. The process 200 can be implemented in a digital instrument system 100 as shown in FIG. 1. Alternatively, the process can be implemented in musical instruments that are equipped with electronic string sensor methodologies.

At 201, a user can produce music notes according to specific music profile. In an exemplary embodiment, the strings can be constructed as sensors configured to simulate layout and feel of strings on a traditional music instrument. The sensors are configured to receive input from user as string would receive interaction from a user on a traditional instrument. In the electronic string instrument method, the input is received and converted into digital data, compared to analog interactions present in traditional musical instruments.

At 202, the music instrument sensors receive input from a user and detects input factors associated therein. Such input factors comprise velocity, force, angle, activation duration, and gestures. The sensors are configured to perceive the interaction a user has with the sensors and interpret the input according to the traditional music instrument it intends to simulate. As such, each interaction of the sensors from the user are analyzed and categorized into appropriate factors.

At 203, music notes are generated based on the user input, as well as the music profile that the instrument system is currently set on. A process is provided within the instrument to associate each sensor interaction with a music note or tone. As such, the input factors would further identify the appropriate music note that the user intends to invoke. The music notes are also organized under music profiles, such that each profile associate a specific collection of music notes. In an exemplary embodiment, a music profile for santoor is implemented, such that pre-recorded notes of santoor strings being played would be generated based on user input factors.

At 204, additional music profiles are received from user devices and incorporated into the music instrument. This process allows different music instrument sound profiles to be utilized in the same digital music instrument system. Therefore, a digital music instrument system is capable of producing multiple instrument's sound.

The process of 201-204 can be repeated until a desired sound is achieved. Each sensor or string can be tuned individually and instantly, wherein such comprehensive and responsive tuning function cannot be achieved by traditional music instruments. A user can repeat the steps to configure the electronic string music instrument system in order to produce the desired music notes.

At 205, a plurality of data elements are produced based on the music notes generated in response to input factors. The data elements can be transmitted to both internal and external playback devices. In various embodiments, integrated speakers can be utilized to instantly generate the playback of the music notes. External audio equipment can be connected directly and/or through a network that would enable playback of the data elements, as in audio systems at a venue or a network of audio broadcasting devices.

### Supported Features and Embodiments

The detailed description provided above in connection with the appended drawings explicitly describes and supports various features of a system and method for implementing an electronic string music instrument. By way of illustration and not limitation, supported embodiments include a musical instrument system with electronically tuned strings. The system comprises an instrument body, which is designed to comprise a plurality of sensors configured to simulate strings on a music instrument. The sensors are designed to receive interaction and input from a user similarly to how strings behave on a string instrument. The system further comprises a processor and at least one output module. The system is implemented with a user control device configured to receive, store, and transmit at least one music profile, an output device, and a network configured to connect the user device and the output device to the instrument body. The sensors are configured to detect input factors when a user interacts with the sensors, wherein the input factors are transmitted to the processor. The processor then directs the output module to produce a number of musical notes based on the input factors and the music profile.

Supported embodiments include the foregoing electronic string instrument system, wherein the sensors are configured with a software routine to identify a plurality of gestures when the user interacts with the sensors.

Supported embodiments include any of the foregoing electronic string instrument systems, wherein output module comprises a headphone jack, a line out jack, a midi output port, and a speaker.

Supported embodiments include any of the foregoing electronic string instrument systems, further comprising a plurality of visual indicators to show when a sensor is activated.

Supported embodiments include any of the foregoing electronic string instrument systems, further comprising at least one digital filter.

Supported embodiments include any of the foregoing electronic string instrument systems, wherein the digital filter can be activated instantly.

Supported embodiments include any of the foregoing electronic string instrument systems, further comprising an integrated metronome and sequencer.

Supported embodiments include a method for producing music with electronically tuned strings, comprising receiving at least one music profile from a user on a user device; tuning a plurality of sensors electronically to correspond to the at music profile; receiving at least one music input from a user interacting with the sensors; detecting at least one music input factors for the music input; transporting the music input factors to a processor; determining, using the processor, a plurality of music notes according to the music input factors; generating, using an output module, music notes on the music instrument based on the user input, adjusted according to the music profile and the music input factors; adjusting the strings instantly upon receiving tuning input from the user; and producing a plurality of musical data elements based on the music notes and transmitting the plurality of musical data elements to an output device.

Supported embodiments include the foregoing method, further comprising using a software routine to identify a plurality of gestures when a user interacts with the sensors.

Supported embodiments include any of the foregoing methods, wherein the plurality of data elements are produced from an output module on the music instrument.

Supported embodiments include any of the foregoing methods, wherein the music input factors comprise velocity, force, activation duration, and angle with which the sensors are activated.

Supported embodiments include any of the foregoing methods,, further comprising displaying string sensor activation through a plurality of visual indicators.

Supported embodiments include any of the foregoing methods, wherein the plurality of musical data elements are in a song file.

Supported embodiments include any of the foregoing methods, wherein the plurality of musical data elements form a data stream.

Supported embodiments include any of the foregoing methods, further comprising: activating a digital filter.

Supported embodiments include any of the foregoing methods, further comprising: activating the digital filter instantly.

Supported embodiments include an apparatus, a device, a computer-readable storage medium, a computer program product and/or means for implementing any of the foregoing systems, methods, or portions thereof.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A musical instrument system with electronically tuned strings, comprising
an instrument comprising a plurality of sensors configured to simulate strings on a music instrument, a processor, and at least one output module,
a user control device configured to receive, store, and transmit at least one music profile,
an output device, and
a network configured to connect the user device and the output device to the instrument body,
wherein,
the sensors are configured to detect input factors when a user interacts with the sensors, wherein the input factors are transmitted to the processor, wherein the processor directs the output module to produce a number of musical notes based on the input factors and the music profile.

2. The system of claim 1, wherein the sensors are configured with a software routine to identify a plurality of gestures when the user interacts with the sensors.

3. The system of claim 1, wherein output module comprises a headphone jack, a line out jack, a midi output port, and a speaker.

4. The system of claim 1, further comprising a plurality of visual indicators to show when a sensor is activated.

5. The system of claim 1, further comprising an integrated metronome and sequencer.

6. The system of claim 1, further comprising at least one digital filter.

7. The system of claim 6, wherein the digital filter can be activated instantly.

8. A method for producing music with an electronic instrument, comprising
receiving at least one music profile from a user on a user device
tuning a plurality of sensors electronically to correspond to the at music profile,
receiving at least one music input from a user interacting with the sensors,
detecting at least one music input factors for the music input,
transporting the music input factors to a processor,
determining, using the processor, a plurality of music notes according to the music input factors,
generating, using an output module, music notes on the musical instrument based on the user input, adjusted according to the music profile and the music input factors,
adjusting the musical instrument instantly upon receiving tuning input from the user, and
producing a plurality of data elements based on the music notes and transmitting the plurality of data elements to an output device.

9. The method of claim 8, further comprising using a software routine to identify a plurality of gestures when a user interacts with the sensors.

10. The method of claim 8, wherein the plurality of data elements are produced from an output module on the music instrument.

11. The method of claim 8, wherein the music input factors comprise velocity, force, activation duration, and angle with which the sensors are activated.

12. The method of claim 8, further comprising displaying string sensor activation through a plurality of visual indicators.

13. The method of claim 8, wherein the plurality of musical data elements are in a song file.

14. The method of claim 8, wherein the plurality of musical data elements form a data stream.

15. The method of claim 8. further comprising:
activating a digital filter.

16. The method of claim 15. further comprising:
activating the digital filter instantly.
